(19) United States
(12) Patent Application Publication
(10) Pub. No.: US 2024/0135057 A1
(43) Pub. Date: Apr. 25, 2024

(54) METHOD FOR NUMERICAL RECONSTRUCTION AND HEAT TRANSFER CHARACTERISTICS EVALUATION OF MICROSTRUCTURE OF THERMAL BARRIER COATINGS CONTAINING MICROCRACKS

(71) Applicant: University of Science and Technology Beijing, Beijing (CN)

(72) Inventors: Ningning LIU, Beijing (CN); Linjing HUANG, Beijing (CN); Ruifeng DOU, Beijing (CN); Mengqi YU, Beijing (CN); Linxi ZHANG, Beijing (CN); Zhi WEN, Beijing (CN); Xunliang LIU, Beijing (CN)

(73) Assignee: University of Science and Technology Beijing, Beijing (CN)

(21) Appl. No.: 18/373,298

(22) Filed: Sep. 27, 2023

(30) Foreign Application Priority Data
Oct. 17, 2022 (CN) 202211264771.2

(51) Int. Cl. G06F 30/20; G06F 111/08; G06F 111/10

(52) U.S. Cl. CPC G06F 30/20; G06F 2111/08; G06F 2111/10

(57) ABSTRACT

A method for numerical reconstruction and heat transfer characteristics evaluation of a microstructure of thermal barrier coatings containing microcracks includes the following steps: determining a simulation area and size settings, generating random microcracks with different morphological characteristics and placing the microcracks in the simulation area, and determining whether a space occupied by the microcracks reaches a porosity ratio of the preset microcracks, building a general pore model of thermal barrier coatings (TBCs) based on the QSGS method, reconstructing true mesoscopic morphologies of the TBCs, determining whether the preset volume fraction has been reached, and building a heat transfer analysis model based on the thermal 1,attice Boltzmann method to calculate heat insulation performance parameters such as temperature distribution, and thermal conductivity. Compared with the prior art, the heat transfer analysis model can restore a mesoscopic structure of the coating more truly and effectively.

### CROSS REFERENCE TO THE RELATED APPLICATIONS

This application is based upon and claims priority to Chinese Patent Application No. 202211264771.2, filed on Oct. 17, 2022, the entire contents of which are incorporated herein by reference.

### TECHNICAL FIELD

The present disclosure relates to the technical field of porous media, and in particular to a method for numerical reconstruction and heat transfer characteristics evaluation of a microstructure of thermal barrier coatings containing microcracks.

### BACKGROUND

In order to make turbine blades have a long service life and high reliability, thermal barrier coatings (TBCs) need to be applied onto surfaces of the turbine blades of high-performance aircraft engine. The technology of TBCs has bright application prospects in the fields of aerospace, weapons, ships, and the like. TBCs made of ceramic materials have the characteristics of high temperature resistance, corrosion resistance, high strength, low thermal conductivity, and the like, and heat insulation effects generated by the TBCs directly affect the service life and running reliability of an engine. A system with TBCs is generally composed of a three-layer structure, that is, a ceramic layer, a bonding layer, and a superalloy substrate. Specifically, the bonding layer mainly adopts MCrAlY alloy (M refers to Fe, Ni, Co, and the like). Because the bonding layer is subjected to thermal cycle oxidation for a long time in the service process, when Al content is consumed to the extent that Al₂O₃ growth cannot be satisfied, a thermally grown oxide will be formed on the interface between the ceramic layer and a transition layer, such that a center of microcrack initiation is formed. The initiation and further expansion of microcracks will produce stress concentration, which will greatly change the temperature distribution of the coating, thereby affecting the thermal insulation performance, service efficiency and durability of the coating

Because microcracks on the TBCs do not have obvious regularity, some scholars establish ideal models to analyze the impact of microcracks on temperature distribution characteristics and heat insulation performance of the TBCs by chiefly simplifying a microstructure of the coating. However, the existing research focuses on presetting microcracks of single composition, which directly simplifies the microcracks int© spheres, ellipsoids or sheets in the same length, direction or size. However, in reality, the TBCs contain microcracks randomly distributed in different sizes, inclinations, numbers, positions and morphologies. Such oversimplified hypothesis models deviate greatly from the actual situation, and calculation results generated therefrom are not universal and applicable.

### SUMMARY

Aiming at defects in the prior art, the present disclosure provides a method for numerical reconstruction and heat transfer characteristics evaluation of a microstructure of thermal barrier coatings containing microcracks, so as to solve the technical problem that a simplified model of the pore structure of thermal barrier coatings (TBCs) containing microcracks deviates greatly from a real coating structure.

In order to achieve the above objective, the present disclosure adopts the following technical solution:

a method for numerical reconstruction and heat transfer characteristics evaluation of a microstructure of thermal barrier coatings containing microcracks, including:

S1: determining a simulation area and size settings, including settings of a physical model and a simulation calculation grid; and generating random microcracks with different morphological characteristics based on the Monte Carlo simulation method and the quartet structure generation set (QSGS) method.

S2: changing the inclination directions of different microcracks by the coordinate transformation method according to a certain statistical law and placing them in the simulation area, and determining whether a space occupied by the microcracks reaches a porosity ratio of the preset microcracks.

S3: building a general pore model of thermal barrier coatings (;TBCs) based on the QSGS method, where a solid skeleton in the TBCs is taken as a growth phase, pores are non-growth phases, the porosity is defined to control a pore volume fraction of the coating, and the generation probability of a nucleation center of the solid skeleton is defined to control the number of the pores; traversing the initially randomly distributed growth nucleus nodes, making each growth nucleus node randomly grow in a three-dimensional space, controlling the generation of the TBCs with different structures according to the growth probabilities of growth nucleus in 26 directions under three-dimensional coordinates, where the growth probability of the growth nucleus of the lamellar structure coating in the horizontal direction is far greater than that of the columnar structure coating, while the columnar structure coating is opposite.

S4: superposing a general pore structure into the simulation area containing microcracks to generate a coating pore model coupled with microcra.ck detects, reconstructing true mesoscopic morphologies of the TBCs, and determining whether the preset volume fraction has been reached.

S5: building a heat transfer analysis model based on the thermal Lattice Boltzmann method to calculate heat insulation performance parameters such as temperature distribution, and thermal conductivity.

It should be noted that the Monte Carlo simulation method is adopted in the step S to generate a microcrack morphology under a certain statistical distribution law:

S1.1 Generating random numbers uniformly distributed over an interval of [0,1]:

an iterative formula of the linear congruential method for generating the random numbers is:

xₙ=(axₙ₋₁+c)(mod M)

where a is a non-negative multiplier; c is a non-negative increment; Mis a modulus; and (mod M) represents a remainder after being divided by m.

further, generating random numbers R uniformly distributed over the interval of

$${R}_{i} = \frac{{x}_{i}}{M}$$

S1.2 Using uniform random number calculation to generate random numbers with other specified statistical distribution law:

The uniform random numbers over the interval of [0,1]generated in the (1) above are used to generate random numbers that obey other distribution types.

For example. the probability density function of a uniform distribution is:

$$f ( x ) = \frac{1}{b - a} ( a \leq x \leq b )$$

A method for calculating random variables is as follows:

x_{f}=(b−a)R+a

in the formula, x_{f} is random numbers required; and R represents random numbers uniformly distributed over the interval [0,1].

S1.3 Carrying out translation and rotational transformation of coordinates to realize changes in the orientation of microcracks:

There are a base coordinate system 0 and a moving coordinate system I, their postures are the same, and their origins are not coincident. For any particle P in a space that is fixedly connected to the coordinate system I, its coordinates in the coordinate system 0 are expressed as P₀=[p₀ₓ pp_{0y} p_{0z}]^{T}, and in the coordinate system I are expressed as P₁=[p₁ₓ p_{1y} p_{1z}]^{T}, and coordinates of the origin O₁ of the coordinate system I are D₀¹=[d₀ₓ d_{0y} d_{0z}]^{T}; there exists P₀=P₁D₀¹ according to the rules for vector operations;

when an attitude change matrix of the coordinate system I relative to the coordinate system 0 is taken into account, relative relationship between them can be considered as a combination of translational motion between the origins and pure rotation around the origins, there exists P₀Rot₀¹P₁D₀¹; similarly P₁Rot₀¹P₀D₁⁰; where Rot represents basic rotation, which is written in a matrix in three-dimensional coordinates in the form of:

$${Rot}_{x , α} = [ \begin{matrix}1 & 0 & 0 & 0 \\ 0 & cos α & - sin α & 0 \\ 0 & sin α & cos α & 0 \\ 0 & 0 & 0 & 1\end{matrix} ]$$

$${Rot}_{y , ϕ} = [ \begin{matrix}cos ϕ & 0 & sin ϕ & 0 \\ 0 & 1 & 0 & 0 \\ - sin ϕ & 0 & cos ϕ & 0 \\ 0 & 0 & 0 & 1\end{matrix} ]$$

$${Rot}_{z , θ} = [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ]$$

The above formulae identify rotation by angles α, ϕ and θ around x, y and z axes, respectively.

S1.4 Generating microcracks, and using the QSGS method to control the growth probability in the length/width direction to 100/1 to ensure that the microcracks are wedge-shaped; controlling the thickness direction of a single microcrack to be two layers of grids, so as to ensure that the microcrack is approximately a lamellar structure; and using the

Monte Carlo simulation method to generate such morphology parameters as nucleation center point (x₀, y₀, z₀), inclination angle φ, inclination angle θ, length, and the number according to a certain statistical distribution law. The nucleation center point (x0, y0, z0) serves as a growth nucleation center of microcracks under QSGS method, the length of the microcracks controls the growth probabilities of the microcracks in different directions, and the inclination angle φ and the inclination angle θ serve as bases for rotational transformation of coordinates, such that microcracks with different shapes, sizes, directions, and the like, distributed according to a certain statistical law are generated.

It should be noted that the algorithm in the step S3 is a circular traversal of the initial growth nucleus nodes and the growth nucleus nodes after growth, does not involve continuous growth of single nodes; further, the growth phase avoids the growth of microcracks in the simulation area and does not overlap the microcracks, and the sum of the porosities of the microcracks and the general pores is equal to the preset total porosity. The three-dimensional coordinates have 26 directions in total, including 6 main directions, 12 face opposite angle directions and 8 body opposite angle directions, the growth nucleus node is taken as the growth origin, and the skeleton regenerates random numbers to non-porous adjacent points in the 6 main directions. When the generated random number is smaller than the growth probability of growth nucleus, the point grows to be a growth phase node; and repeating this step until the growth phase meets the preset volume fraction.

It should be noted that the governing equation for heat conduction in the step S5 can be expressed as:

$${( ρ {c}_{p} )}_{f} ( \frac{\partial T}{\partial t} ) = {λ}_{f} {∇}^{2} T , {( ρ {c}_{p} )}_{s} ( \frac{\partial T}{\partial t} ) = {λ}_{s} {∇}^{2} T$$

In the equation, the subscriptl represents air in pores, s represents a solid skeleton, T represents a temperature of the material, and p, λ and cₚ represent density, thermal conductivity coefficient and specific heat capacity at constant pressure, respectively.

Based on the above equation, a D3Q19 thermal Lattice Boitzmann model is adopted, and a temperature evolution equation is as follows:

$${g}_{α} ( r + {e}_{α} , t + {δ}_{t} ) - {g}_{α} ( r , t ) = - \frac{1}{τ} [ {g}_{α} ( r , t ) - {g}^{eq} ( r , t ) ]$$

In the equation, r is a position vector, t is the time, δₜ is the time step, and α=0, 1, . . . ,18 represent 19 discrete velocity directions, where e_{λ} is a discrete velocity distribution equation:

$${e}_{α} = [ \begin{matrix}0 & 1 & - 1 & 0 & 0 & 0 & 0 & 1 & - 1 & 1 & - 1 & 1 & - 1 & 1 & - 1 & 0 & 0 & 0 & 0 \\ 0 & 0 & 0 & 1 & - 1 & 0 & 0 & 1 & - 1 & - 1 & 1 & 0 & 0 & 0 & 0 & 1 & - 1 & 1 & - 1 \\ 0 & 0 & 0 & 0 & 0 & 1 & - 1 & 0 & 0 & 0 & 0 & 1 & - 1 & - 1 & 1 & 1 & - 1 & - 1 & 1\end{matrix} ]$$

g^{e1}(r,t) represents an equilibrium distribution function of the temperature, as shown in the following equation:

$${g}^{eq} ( r , t ) = \{ \begin{matrix}1 / 3 T & α = 0 \\ 1 / 18 T & α = 1 - 7 \\ 1 / 36 T & α = 8 - 18\end{matrix}$$

The relationship between dimensionless relaxation time τ and thermal diffusivity λ is:

$$τ = 3 \frac{λ}{ρ {c}_{p}} + 0.5$$

Both the grid interface and the gas-solid boundary conditions adopt a non-equilibrium extrapolation format:

g_{α}(r+e_{α}, t+δₜ)=g_{α}^{(eq)}(r+e_{α}, t+δₜ)−g_{α}^{(ne)}(r+e_{α},t+δₜ)+[g_{α}(r,t)−g_{α}^{eq}(r,t)]

The corresponding macroscopic temperature and heat flux can be determined by the

following formula:

$$T = {\sum }_{α} {g}_{α} , q = ( {\sum }_{α} {e}_{α} {g}_{α} ) \frac{τ - 0.5}{τ} ρ {c}_{p}$$

after the temperature field is determined, the calculation formula of the effective thermal conductivity λ_{eff} can be expressed as:

λ_{eff}=qS/ΔT

in the formula, q is a steady-state heat flow through the coating with a thickness of δt, and ΔT represents a temperature differences between the upper and lower boundaries.

It should be noted that equal (ρcₚ) values are selected during calculation, and a (ρcₚ) value of air can be used as a reference value in the actual simulation; for the air in general solids and pores, it should be ensured that (τ_{gf}−0.5)/(τ_{gs}−0.5)=λ_{f}/λₛ, so as to reflect the difference between them in the heat-conducting property, and it is ensured that τÅ(0.5˜2.0), so as to ensure the convergence of simulation in lattice units.

The present disclosure has the beneficial effects: the model of the present disclosure can restore a mesoscopic structure of the coating more truly and effectively, thereby cutting down the cost caused by scanning of a large amount of real coating samples, and predicting the heat insulation effect of the TBCs more accurately.

### BRIEF DESCRIPTION OF THE DRAWINGS

FIG. 1 is a schematic flowchart of the present disclosure;

FIG. 2 shows the growth probabilities of a single microcra.ck in different directions according to the present disclosure;

FIGS. 3A-3D are schematic diagrams of a morphology of a single wedge-shaped lamellar microcrack at different angles according to the present disclosure, where FIG. 3A is a section of an x-z axis, FIG. 3B is a section of a y-z axis, FIG. 3C is a section of an x-y axis, and FIG. 3D is a three-dimensional front view;

FIGS. 4A-4D are schematic diagrams of a model of a plurality of microcracks according to the present disclosure, where FIGS. 4A-4D illustrate morphologies of the microcracks under different statistical distribution law;

FIGS. 5A-5C are schematic structural diagrams of a general pore model of the TBCs according to present disclosure, where FIG. 5A shows a lamellar structure coating, FIG. 5B shows a porous structure coating, and FIG. SC shows a columnar structure coating.

FIG. 6 is a schematic diagram of a y-z axis cross-section of a lamellar structure coating containing microcracks according to the present disclosure;

FIGS. 7A-7B are schematic diagrams of a simulated coating temperature field distribution according to the present disclosure, where, with the same crack/pore ratio, FIG. 7A represents a temperature field of a lamellar structure coating with (a1) or without (a2-a5) microcracks of different sizes, and 7B represents a temperature field of a columnar structure coating with (b1) or without (b2-b5) microcra.cks of different sizes; and.

FIG. 8 is a diagram of comparison between numerical simulation results and the literature in terms of the effective thermal conductivity of a coating changing with microcrack parameters according to the present disclosure.

### DETAILED DESCRIPTIONS OF THE EMBODIMENTS

The present disclosure will be further described below. It should be noted that the following embodiment is based on this technical solution and provide detailed implementation and specific operating procedures, but the protection scope of the present disclosure is not limited to this embodiments.

### Embodiment

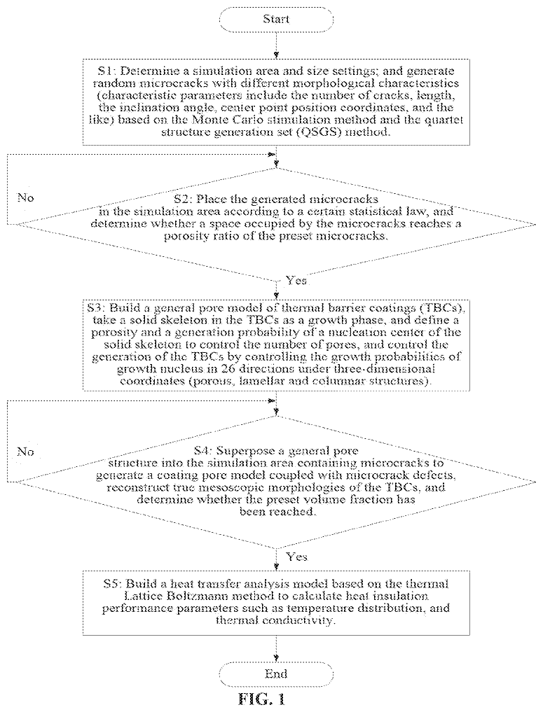

As shown in FIG. 1, the present disclosure provides a method for numerical reconstruction and heat transfer characteristics evaluation of a microstructure of thermal hauler coatings containing microcracks, and the method has a low cost and can truly and effectively characterize both internal structural and morphological characteristics of the coatings, specifically including the following steps:

S1 determining a simulation area and size settings, mainly including settings of a physical model and a simulation calculation grid; and generating random microcracks with different morphological characteristics (characteristic parameters include the number of cracks, length, the inclination angle, center point position coordinates, and the like) based on the Monte Carlo simulation method and the quartet structure generation set (QSGS) method.

The Monte Carlo simulation method is adopted to generate a microcrack morphology (including the number of cracks, length, the inclination angle, center point position coordinates, and the like) under a certain statistical distribution law:

(1) Generating random numbers uniformly distributed over an interval of [0,1]:

an iterative formula of the linear congruential method for generating the random numbers is:

xₙ(axₙ₋₁+c)(mod M)

in the formula, a is a non-negative multiplier; c is a non-negative increment; M is a modulus; and (mod M) represents a remainder after being divided by in.

Random numbers I? uniformly distributed over the interval of [0,1] are thus generated:

$${R}_{i} = \frac{{x}_{i}}{M}$$

(2) Using uniform random number calculation to generate random numbers with other specified statistical distribution law:

the uniform random numbers over the interval of [0,1] generated in the (1) above are used to generate random numbers that obey other distribution types (such as uniform distribution, exponential distribution, normal distribution, and logarithmic normal distribution). For example, the probability density function of a uniform distribution is:

$$f ( x ) = \frac{1}{b - a} ( a \leq x \leq b )$$

A method for calculating random variables is as follows:

x_{f}=(b−a)R+a

in the formula, AT is random numbers required; and R represents random numbers uniformly distributed over the interval [0,1].

(3) Carrying out translation and rotational transformation of coordinates to realize changes in the orientation of microcracks:

there are a base coordinate system 0 and a moving coordinate system I, their postures are the same, and their origins are not coincident. For any particle P in a space that is fixedly connected to the coordinate system I, its coordinates in the coordinate system 0 are expressed as P₀=[p₀ₓ pp_{0y} p_{0z}]^{T}, and in the coordinate system I are expressed as P₁=[p₁ₓ p_{1y} p_{1z}]^{T}, and coordinates of the origin O₁ of the coordinate system I are D₀¹=[d₀ₓ d_{0y} d_{0z}]^{T}; there exists P₀=P₁D₀¹ according to the rules for vector operations; when an attitude change matrix of the coordinate system I relative to the coordinate system 0 is taken into account, relative relationship between them can be considered as a combination of translational motion between the origins and pure rotation around the origins, there exists P₀Rot₀¹P₁D₀¹; similarly P₁Rot₀¹P₀D₁⁰; where Rot represents basic rotation, which is written in a matrix in three-dimensional coordinates in the form of:

$${Rot}_{x , α} = [ \begin{matrix}1 & 0 & 0 & 0 \\ 0 & cos α & - sin α & 0 \\ 0 & sin α & cos α & 0 \\ 0 & 0 & 0 & 1\end{matrix} ]$$

$${Rot}_{y , ϕ} = [ \begin{matrix}cos ϕ & 0 & sin ϕ & 0 \\ 0 & 1 & 0 & 0 \\ - sin ϕ & 0 & cos ϕ & 0 \\ 0 & 0 & 0 & 1\end{matrix} ]$$

$${Rot}_{z , θ} = [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ]$$

The above formulae identify rotation by angles a, $ and 0 around x, y and z axes, respectively.

(4) Generating microcracks.

The QSGS method is adopted to generate a single microcrack and determine the morphology of the single mi crocrack:

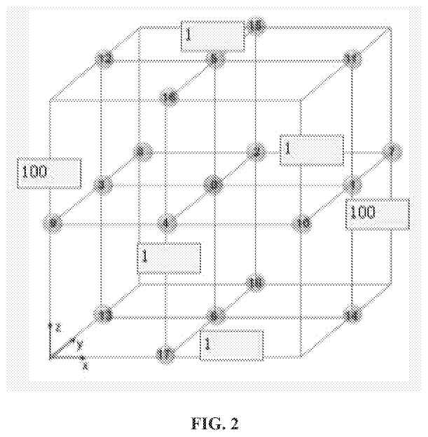

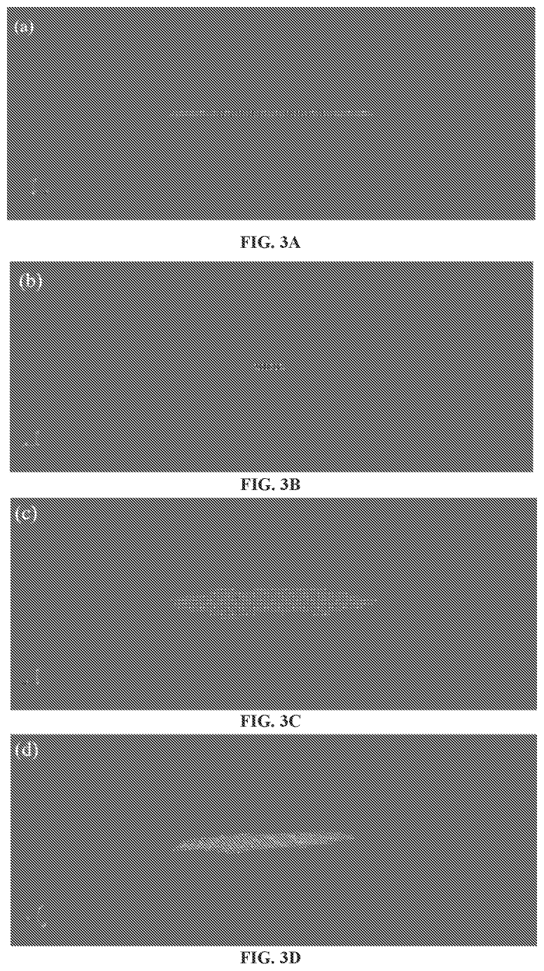

the microcrack is generally wedge-shaped lamellar. As shown in FIG. 2, the microcrack can be ensured to be wedge-shaped by using the QSGS method to control the growth probability in the length/width direction to 100/1, and the structure of the wedge-shaped microcrack is shown in FIG. 3C; the thickness direction of the single microcrack is controlled only by two layers of grids, with a thickness of 2 μm, so as to ensure that the microcrack is approximately a lamellar structure, as shown in FIGS. 3A and 3B; and FIG. 3D is a three-dimensional front view of a generated single wedge-layer lamellar microcrack.

The Monte Carlo simulation t ethod is further adopted to generate such morphology parameters as nucleation center point (x₀, y₀, z₀), inclination angle φ, inclination angle θ, length, and the number according to a certain statistical distribution law. The nucleation center point (x₀, y₀, z₀) serves as a growth nucleation center of microcracks under Q5CiS method, the length of the microcracks controls the growth probabilities of the microcracks in different directions, and the inclination angle φ and the inclination angle θ serve as bases for rotational transformation of coordinates, such that microcracks with different shapes, sizes, directions, and the like, distributed according to a certain statistical law are generated.

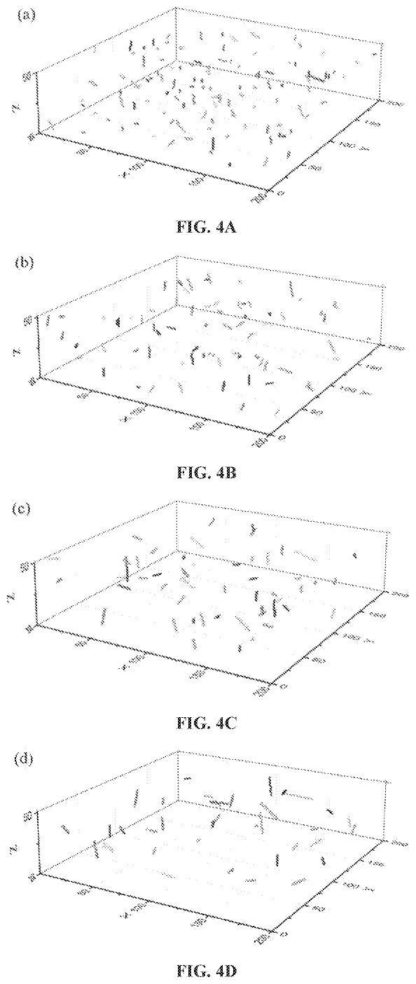

S2: changing the inclination directions of different microcracks by the coordinate transformation method according to a certain statistical law and placing them in the simulation area, FIGS. 4A-4D are schematic diagrams of a model of a plurality of microcracks in the present disclosure, and FIGS. 4A-4D illustrate morphologies of the microcracks under different statistical distribution law; and determining whether a space occupied by the microcracks reaches a porosity ratio of the preset microcracks.

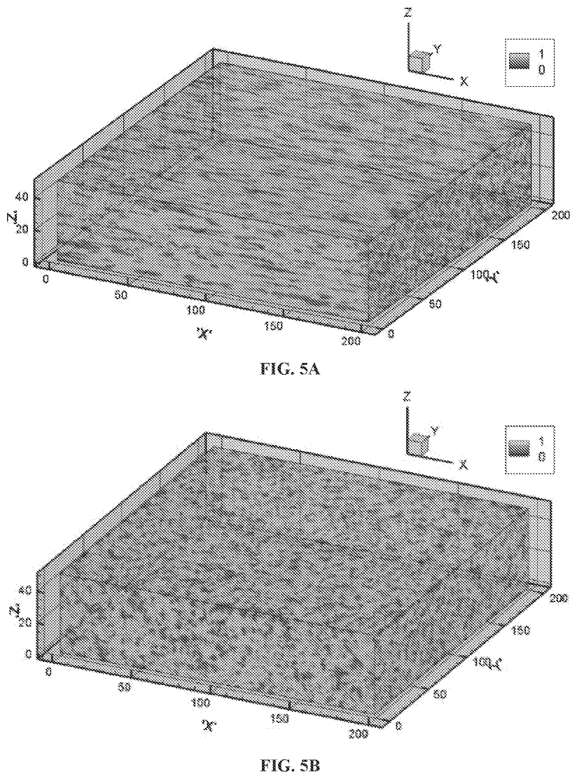

S3: building a general pore model of thermal barrier coatings (TBCS) based on the QSGS method, where a solid skeleton in the TBCs is taken as a growth phase, pores are non-growth phases, settings of the porosity controls a pore volume fraction of the coating, and settings of the generation probability of a nucleation center of the solid skeleton controls the number of the pores; traversing the initially randomly distributed growth nucleus nodes, making each growth nucleus node randomly grow in a three-dimensional space, and controlling the generation of the TBCs with different structures (porous, lamellar and columnar structures) according to the growth probabilities of growth nucleus in 26 directions under three-dimensional coordinates, where the growth probability of the growth nucleus of the lamellar structure coating in the horizontal direction is far greater than that of the columnar structure coating, while the columnar structure coating is opposite, and FIGS. 5A-5C are schematic structural diagrams of a general pore model of the TBCs of the present disclosure, FIG, 5A shows a lamellar structure coating, FIG, 5B shows a porous structure coating, and FIG. 5C shows a columnar structure coating.

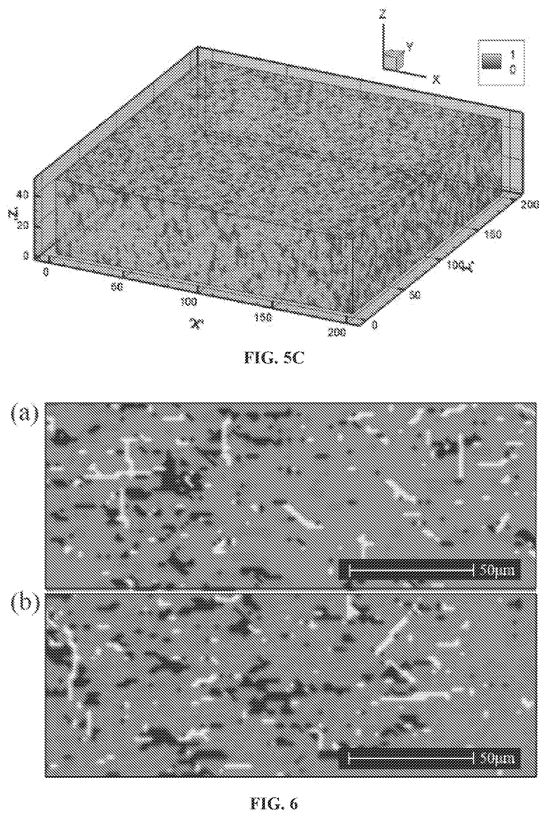

S4: superposing a general pore structure into the simulation area containing microcracks to generate a coating pore model coupled with microcrack defects, reconstructing true mesoscopic morphologies of the TBCs, and determining whether the preset volume fraction has been reached. FIG. 6 is a schematic diagram of a y-z axis cross-section of a lamellar structure coating containing microcracks of the present disclosure, it can be seen that the coating cross section has an apparent lamellar structure, with a large number of unbonded areas between the layers, and a large number of microcracks and spherical micropores within the layers, which is highly similar to the true morphologies of the TBCs. The algorithm in the step S3 is a circular traversal of the initial growth nucleus nodes and the growth nucleus nodes after growth, does not involve continuous growth of single nodes; further, the growth phase avoids the growth of microcracks in the simulation area and does not overlap the microcracks, and the sum of the porosities of the microcracks and the general pores is equal to the preset total porosity. The three-dimensional coordinates have 26 directions in total, including 6 main directions, 12 face opposite angle directions and 8 body opposite angle directions, the growth nucleus node is taken as the growth origin, and the skeleton regenerates random numbers to non-porous adjacent points in the 6 main directions. When the generated random number is smaller than the growth probability of growth nucleus, the point grows to be a growth phase node. Repeating this step until the growth phase meets the preset volume fraction.

S5: building a heat transfer analysis model based on the thermal Lattice Boltzmann method to calculate heat insulation performance parameters such as temperature distribution, and thermal conductivity. Compared with the prior art, the heat transfer analysis model can restore a mesoscopic structure of the coating more truly and effectively, thereby cutting down the cost caused by scanning of a large amount of real coating samples, and predicting the heat insulation effect of the TBCs more accurately.

The governing equation for heat conduction can be expressed as:

$${( ρ {c}_{p} )}_{f} ( \frac{\partial T}{\partial t} ) = {λ}_{f} {∇}^{2} T , {( ρ {c}_{p} )}_{s} ( \frac{\partial T}{\partial t} ) = {λ}_{s} {∇}^{2} T$$

in the equation, the subscript f represents air in pores, s represents a solid skeleton, T represents a temperature of the material, and p, λ and cₚ represent density, thermal conductivity coefficient and specific heat capacity at constant pressure, respectively.

Based on the above equation, a D3Q19 thermal Lattice Boltzmann model is adopted, and a temperature evolution equation is as follows:

$${g}_{α} ( r + {e}_{α} , t + {δ}_{t} ) - {g}_{α} ( r , t ) = \frac{1}{τ} [ {g}_{α} ( r , t ) - {g}^{eq} ( r , t ) ]$$

in the equation, r is a position vector, t is the time, δₜ is the time step, and α=0, . . . , 18 represent 19 discrete velocity directions, where e_{α} is a discrete velocity distribution equation:

$${e}_{α} = [ \begin{matrix}0 & 1 & - 1 & 0 & 0 & 0 & 0 & 1 & - 1 & 1 & - 1 & 1 & - 1 & 1 & - 1 & 0 & 0 & 0 & 0 \\ 0 & 0 & 0 & 1 & - 1 & 0 & 0 & 1 & - 1 & - 1 & 1 & 0 & 0 & 0 & 0 & 1 & - 1 & 1 & - 1 \\ 0 & 0 & 0 & 0 & 0 & 1 & - 1 & 0 & 0 & 0 & 0 & 1 & - 1 & - 1 & 1 & 1 & - 1 & - 1 & 1\end{matrix} ]$$

g^{eq}(r,t) represents an equilibrium distribution function of the temperature, as shown in the following equation:

$${g}^{eq} ( r , t ) = \{ \begin{matrix}1 / 3 T & α = 0 \\ 1 / 18 T & α = 1 - 7 \\ 1 / 36 T & α = 8 - 18\end{matrix}$$

the relationship between dimensionless relaxation time r and thermal diffusivity), is:

$$τ = 3 \frac{λ}{ρ {c}_{p}} + 0.5$$

generally, equal (ρcₚ) values are selected during calculation, and a (pep) value of air can be used as a reference value in the actual simulation; for the air in general solids and pores, it should be ensured that (τ_{gf}−0.5)/(τ_{gs}−0.5)=λ_{f}/λₛ, so as to reflect the difference between them in the heat-conducting property, and it is ensured that τ∈(0.5˜2.0), so as to ensure the convergence of simulation in lattice units.

both the grid interface and the gas-solid boundary conditions adopt a non-equilibrium extrapolation format:

g_{α}(r+e_{α}, t+δₜ)=g_{α}^{(eq)}(r+e_{α}, t+δₜ)−g_{α}^{(ne)}(r+e_{α},t+δₜ)+[g_{α}(r,t)−g_{α}^{eq}(r,t)]

the corresponding macroscopic temperature and heat flux can be determined by the following formula:

$$T = {\sum }_{α} {g}_{α} , q = ( {\sum }_{α} {e}_{α} {g}_{α} ) \frac{τ - 0.5}{τ} ρ {c}_{p}$$

after the temperature field is determined, the calculation formula of the effective thermal conductivity λ_{eff} be expressed as:

λ_{eff}qS/ΔT

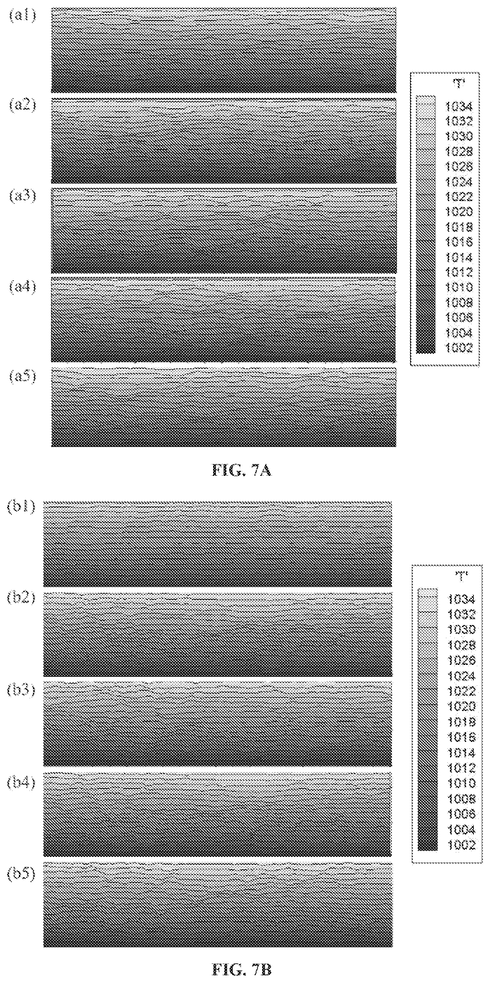

in the formula, q is a steady-state heat flow through the coating with a thickness of δt, and ΔT represents a temperature differences between the upper and lower boundaries. 101141 FIGS. 7A-7B are schematic diagrams of a simulated coating temperature field distribution of the present disclosure. With the same crack/pore ratio, FIG, 7A represents a temperature field of a lamellar structure coating with (a1) or without (a2-a5) microcracks of different sizes. FIG, 7B represents a temperature field of a columnar structure coating with (b1) or without (b2-b5) microcracks of different sizes.

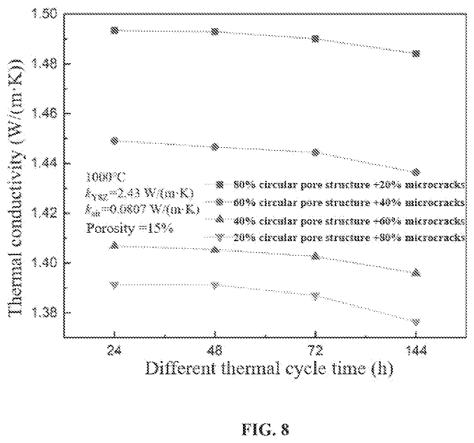

FIG. 8 shows numerical simulation results of the effective thermal conductivity of a coating changing with microcrack parameters of the present disclosure. As can be seen from the figure, the thermal conductivity gradually decreases as the crack ratio increases. Therefore, the numerical reconstruction model of the TBCs built by the present disclosure can play a certain guiding role in preparing and using the TBCs, and can reflect the evolution law of the thermal insulation performance of the TBCs.

Those skilled in the art can make various modifications and variations of the present disclosure based on the above technical solutions and concepts, and all these modifications and variations should be included in the protection scope of the claims of the present disclosure.

What is claimed is:

1. A method for numerical reconstruction and heat transfer characteristics evaluation of a microstructure of thermal barrier coatings containing microcracks, comprising:
S1:determining a simulation area and size settings, comprising settings of a physical model and a simulation calculation grid; and generating random microcracks with different morphological characteristics based on a Monte Carlo simulation method and a quartet structure generation set (QSGS) method;
S2: changing inclination directions of different microcracks by a coordinate transformation method according to a certain statistical law and placing them in the simulation area, and determining whether a space occupied by the microcracks reaches a porosity ratio of preset microcra.cks,
S3: building a general pore model of thermal barrier coatings (TBCs) based on the QSGS method, wherein a solid skeleton in the TBCs is taken as a growth phase, pores are non-growth phases, settings of the porosity controls a pore volume fraction of the coating, and settings of a generation probability of a nucleation center of the solid skeleton controls a number of the pores; traversing the initially randomly distributed growth nucleus nodes, making each growth nucleus node randomly grow in a three-dimensional space, controlling the generation of the TBCs with different structures according to the growth probabilities of growth nucleus in 26 directions under three-dimensional coordinates, wherein the growth probability of the growth nucleus of a lamellar structure coating in a horizontal direction is far greater than that of the columnar structure coating, and the columnar structure coating is opposite;
S4: superposing a general pore structure into the simulation area containing microcracks to generate a coating pore model coupled with microcrack defects, reconstructing true mesoscopic morphologies of the TBCs, and determining whether the preset volume fraction has been reached;
S5: building a heat transfer analysis model based on a thermal Lattice Boltzmann method to calculate heat insulation performance parameters such as temperature distribution, and thermal conductivity, and using the Monte Carlo simulation method in the step Si to generate a microcrack morphology under a certain statistical distribution law:
S1.1 generating random numbers uniformly distributed over an interval of [0,1]:
an iterative formula of a linear congruential method for generating the random numbers is:
xₙ=(axₙ₋₁+c)(mod M)
in the formula, a is a non-negative multiplier; c is a non-negative increment; M is a modulus; and (mod M) represents a remainder after being divided by in;
random numbers R uniformly distributed over the interval of [0,1] are thus generated:
$${R}_{i} = \frac{{x}_{i}}{M}$$
S1,2 using uniform random number calculation to generate random numbers with other specified statistical distribution law:
the uniform random numbers over the interval of [0,1] generated in the (1) above are used to generate random numbers that obey other distribution types;
the probability density function of a uniform distribution is:
$$f ( x ) = \frac{1}{b - a} ( a \leq x \leq b )$$
a method for calculating random variables is as follows:
x_{f}(b−a)R+a
in the formula, x_{f} is random numbers required; and R represents random numbers uniformly distributed over the interval [0,1];
S1.3 carrying out translation and rotational ransformation of coordinates to realize changes in the orientation of microcracks:
there are a base coordinate system 0 and a moving coordinate system I, their postures are the same, and their origins are not coincident. For any particle P in a space that is fixedly connected to the coordinate system I, its coordinates in the coordinate system 0 are expressed as P₀=[p₀ₓ pp_{0y} p_{0z}]^{T}, and in the coordinate system I are expressed as P₁=[p₁ₓ p_{1y} p_{1z}]^{T}, and coordinates of the origin O₁ of the coordinate system I are D₀¹=[d₀ₓ d_{0y} d_{0z}]^{T}; there exists P₀=P₁D₀¹ according to the rules for vector operations; when an attitude change matrix of the coordinate system I relative to the coordinate system 0 is taken into account, relative relationship between them can be considered as a combination of translational motion between the origins and pure rotation around the origins, there exists P₀Rot₀¹P₁D₀¹; similarly P₁Rot₀¹P₀D₁⁰; where Rot represents basic rotation, which is written in a matrix in three-dimensional coordinates in the form of:
$${Rot}_{x , α} = [ \begin{matrix}1 & 0 & 0 & 0 \\ 0 & cos α & - sin α & 0 \\ 0 & sin α & cos α & 0 \\ 0 & 0 & 0 & 1\end{matrix} ]$$
$${Rot}_{y , ϕ} = [ \begin{matrix}cos ϕ & 0 & sin ϕ & 0 \\ 0 & 1 & 0 & 0 \\ - sin ϕ & 0 & cos ϕ & 0 \\ 0 & 0 & 0 & 1\end{matrix} ]$$
$${Rot}_{z , θ} = [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ]$$
the above formulae identify rotation by angles a, 0 and 0 around x, y and z axes, respectively; and
S1.4 generating microcracks, and using the QSGS method to control the growth probability in the length/width direction to 100/1 to ensure that the microcracks are wedge-shaped; controlling the thickness direction of a single microcrack to be two layers of grids, so as to ensure that the microcrack is approximately a lamellar structure; and using the Monte Carlo simulation method to generate such morphology parameters as nucleation center point (x₀, y₀, z₀), inclination angle φ, inclination angle θ, length, and the number according to a certain statistical distribution law, wherein the nucleation center point (x0, y0, z0) serves as a growth nucleation center of microcracks under QSGS method, the length of the microcracks controls the growth probabilities of the microcracks in different directions, and the inclination angle φ and the inclination angle θ serve as bases for rotational transformation of coordinates, such that microcracks with different shapes, sizes, directions, and the like, distributed according to a certain statistical law are generated, and the algorithm in the step 83 is a circular traversal of the initial growth nucleus nodes and the growth nucleus nodes after growth; further, the growth phase avoids the growth of microcra.cks in the simulation area and does not overlap the microcra.cks, and the sum of the porosities of the microcracks and the general pores is equal to the preset total porosity; the three-dimensional coordinates have 26 directions in total, comprising 6 main directions, 12 face opposite angle directions and 8 body opposite angle directions, the growth nucleus node is taken as the growth origin, and the skeleton regenerates random numbers to non-porous adjacent points in the 6 main directions; when the generated random number is smaller than the growth probability of growth nucleus, the point grows to be a growth phase node; and
repeating this step until the growth phase meets the preset volume fraction.

2. The method for numerical reconstruction and heat transfer characteristics evaluation of the microstructure of thermal barrier coatings containing microcracks according to claim 1 ;
wherein the governing equation for heat conduction in the step S5 is expressed as:
$${( ρ {c}_{p} )}_{f} ( \frac{\partial T}{\partial t} ) = {λ}_{f} {∇}^{2} T , {( ρ {c}_{p} )}_{s} ( \frac{\partial T}{\partial t} ) = {λ}_{s} {∇}^{2} T$$
in the equation, the subscript f represents air in pores, s represents a solid skeleton, T represents a temperature of the material, and ρ, λ, and cₚ represent density, thermal conductivity coefficient and specific heat capacity at constant pressure, respectively;
based on the above equation, a D3Q19 thermal Lattice Boltzmann model is adopted, and a temperature evolution equation is as follows:
$${g}_{α} ( r + {e}_{α} , t + {δ}_{t} ) - {g}_{α} ( r , t ) = - \frac{1}{τ} [ {g}_{α} ( r , t ) - {g}^{eq} ( r , t ) ]$$
in the equation, r is a position vector, t is the time, δₜ is the time step, and α=0, . . . , 18 represent 19 discrete velocity directions, wherein e_{α} is a discrete velocity distribution equation:)
$${e}_{α} = [ \begin{matrix}0 & 1 & - 1 & 0 & 0 & 0 & 0 & 1 & - 1 & 1 & - 1 & 1 & - 1 & 1 & - 1 & 0 & 0 & 0 & 0 \\ 0 & 0 & 0 & 1 & - 1 & 0 & 0 & 1 & - 1 & - 1 & 1 & 0 & 0 & 0 & 0 & 1 & - 1 & 1 & - 1 \\ 0 & 0 & 0 & 0 & 0 & 1 & - 1 & 0 & 0 & 0 & 0 & 1 & - 1 & - 1 & 1 & 1 & - 1 & - 1 & 1\end{matrix} ]$$
g^{eq}(r,t) represents an equilibrium distribution function of the temperature, as shown in the following equation:
$${g}^{eq} ( r , t ) = \{ \begin{matrix}1 / 3 T & α = 0 \\ 1 / 18 T & α = 1 - 7 \\ 1 / 36 T & α = 8 - 18\end{matrix}$$
the relationship between dimensionless relaxation time r and thermal diffusivity is:
$$τ = 3 \frac{λ}{ρ {c}_{p}} + 0.5$$
both the grid interface and the gas-solid boundary conditions adopt a non-equilibrium extrapolation format:
g_{α}(r+e_{α}, t+δₜ)=g_{α}^{(eq)}(r+e_{α}, t+δₜ)−g_{α}^{(ne)}(r+e_{α},t+δₜ)+[g_{α}(r,t)−g_{α}^{eq}(r,t)]
the corresponding macroscopic temperature and heat flux is determined by the following formula:
$$T = {\sum }_{α} {g}_{α} , q = ( {\sum }_{α} {e}_{α} {g}_{α} ) \frac{τ - 0.5}{τ} ρ {c}_{p}$$
after the temperature field is determined, the calculation formula of the effective thermal conductivity), λ_{eff} is expressed as:
λ_{eff}=qδ/ΔT
in the formula, q is a steady-state heat flow through the coating with a thickness of δt, and ΔT represents a temperature difference between the upper and lower boundaries.

3. The method for numerical reconstruction and heat transfer characteristics evaluation of the microstructure of thermal barrier coatings containing microcracks according to claim 2, wherein equal (ρcₚ) values are selected during calculation, and a (ρcₚ) value of air is used as a reference value in the actual simulation; for the air in general solids and pores, it should be ensured that (τ_{gf}−0.5)/(τ_{gs}−0.5)=λ_{f}/λₛ, so as to reflect the difference between them in the heat-conducting property, and it is ensured that τ∈(0.5˜2.0), so as to ensure the convergence of simulation in lattice units.
